(19) United States
(12) Patent Application Publication
(10) Pub. No.: US 2018/0066126 A1
(43) Pub. Date: Mar. 8, 2018

(54) TRANSPARENT PRESSURE SENSING FILM WITH HYBRID PARTICLES

(71) Applicants: Rohm and Haas Electronic Materials LLC, Marlborough, MA (US); DOW GLOBAL TECHNOLOGIES LLC, Midland, MI (US)

(72) Inventors: Minbiao Hu, Shanghai (CN); Peng Gao, Shanghai (CN); Chao Zhang, Shanghai (CN); Daniel L. Dermody, Midland, MI (US); Yang Liu, Shanghai (CN); Tong Sun, Shanghai (CN); Xiang Geng, Shanghai (CN); Peter Trefonas, III, Medway, MA (US); Michael E. Hus, Midland, MI (US); Liang Chen, Midland, MI (US); Zhuo Wang, Shanghai (CN)

(21) Appl. No.: 15/561,202

(22) PCT Filed: Mar. 30, 2015
(86) PCT No.: PCT/CN2015/075360

§ 371 Date: Sep. 25, 2017

(51) Int. Cl. C08K 9/06; C08K 9/02; C08K 3/22; G06F 3/045

(52) U.S. Cl. CPC C08K 9/06; C08K 9/02; C08K 3/22; G06F 2203/04103; C08K 2003/2231; C08K 3/2279; G06F 2203/04104; G06F 3/045

(57) ABSTRACT

A transparent pressure sensing film is provided having a matrix polymer; and, a plurality of hybrid particles; wherein the plurality of hybrid particles are disposed in the matrix polymer; wherein each hybrid particle in the plurality of hybrid particles, comprises a plurality of primary particles bonded together with an inorganic binder; wherein an electrical resistivity of the transparent pressure sensing film is variable in response to an applied pressure having a z-component directed along the thickness of the transparent pressure sensing film such that the electrical resistivity is reduced in response to the z-component of the applied pressure.

The present invention relates to a transparent pressure sensing film with hybrid particles. The present invention is also directed to a method of making transparent pressure sensing films and devices comprising the same.

The market for electronic display devices, such as, televisions, computer monitors, cell phones and tablets is a competitive arena in which various product developers are in constant competition to provide improved product features at a competitive price.

Many electronic display devices both convey and receive information from the user through their display interface. Touch screens offer an intuitive means for receiving input from a user. Such touch screens are particularly useful for devices where alternative input means, e.g., mouse and keyboard, are not practical or desired.

Several touch sensing technologies have been developed including, resistive, surface acoustic wave, capacitive, infrared, optical imaging, dispersive signal and acoustic pulse. Each of these technologies operate to sense the position of a touch or touches (i.e., multi-touch) on a display screen. These technologies; however, do not respond to the magnitude of the pressure applied to the screen.

Touch sensitive devices responsive to the location and applied pressure of a touch are known. Such touch sensitive devices typically employ electrically active particles dispersed in a polymeric matrix material. The optical properties of these devices; however, are generally not compatible for use in electronic display device applications.

Accordingly, what is needed is a pressure sensing film that facilitates conventional touch and multi touch capabilities in combination with a pressure sensing capability and that is also optically transparent to facilitate use in optical display touch sensing devices.

Lussey et al. disclose a composite material adapted for touch screen devices. Specifically, in U.S. Patent Application Publication No. 20140109698, Lussey et al. disclose an electrically responsive composite material specifically adapted for touch screen, comprising a carrier layer having a length and a width and a thickness that is relatively small compared to said length and said width. The composite material also comprises a plurality of electrically conductive or semi-conductive particles. The particles are agglomerated to form a plurality of agglomerates dispersed within the carrier layer such that each said agglomerate comprises a plurality of the particles. The agglomerates are arranged to provide electrical conduction across the thickness of the carrier layer in response to applied pressure such that the electrically responsive composite material has a resistance that reduced in response to applied pressure. Lussey et al. further disclose that the electrically conductive or semi-conductive particles may be preformed into granules as described in WO 99/38173. Those preformed granules comprising electrically active particles coated with very thin layers of polymer binder.

Notwithstanding, there remains a continuing need for pressure sensing films that are optically transparent and facilitate production of touch sensitive displays that enable conventional touch and multi-touch inputs in addition to a pressure input.

The present invention provides a transparent pressure sensing film, comprising: a matrix polymer; and, a plurality of hybrid particles; wherein the plurality of hybrid particles are disposed in the matrix polymer; wherein the transparent pressure sensing film has a length, a width, a thickness, T, and an average thickness, T_{avg}; wherein the average thickness, T_{avg}, is 0.2 to 1,000 μm; wherein each hybrid particle in the plurality of hybrid particles, comprises a plurality of primary particles bonded together with an inorganic binder; wherein the plurality of hybrid particles has an average particle size, PS_{avg}, of 1 to 50 μm; wherein the plurality of primary particles is selected from the group consisting of electrically conductive particles and electrically semiconductive particles; wherein the matrix polymer is electrically non-conductive; wherein an electrical resistivity of the transparent pressure sensing film is variable in response to an applied pressure having a z-component directed along the thickness of the transparent pressure sensing film such that the electrical resistivity is reduced in response to the z-component of the applied pressure.

The present invention provides a method of providing a transparent pressure sensing film according to the present invention, comprising: providing a matrix polymer, wherein the matrix polymer is elastically deformable from a quiescent state; providing a plurality of hybrid particles, wherein each hybrid particle in the plurality of hybrid particles, comprises a plurality of primary particles bonded together with an inorganic binder; wherein the plurality of primary particles is selected from the group consisting of conductive particles and semiconductive particles; and, wherein the plurality of hybrid particles has an average particle size, PS_{avg}, of 1 to 50 μm; and, providing a solvent selected from the group consisting of terpineol, dipropylene glycol methyl ether acetate, dipropylene glycol monomethyl ether, propylene glycol n-propyl ether, dipropylene glycol n-propyl ether, cyclohexanone, butyl carbitol, propylene glycol monomethyl ether acetate, xylene and mixtures thereof; dispersing the matrix polymer and the plurality of hybrid particles in the solvent to form a film forming composition; depositing the film forming composition on a substrate; and, curing the film forming composition to provide the transparent pressure sensing film on the substrate.

The present invention provides a device comprising: a transparent pressure sensing film according to claim 1; and, a controller coupled to the transparent pressure sensing film for sensing a change in resistance when pressure is applied to the transparent pressure sensing film.

### BRIEF DESCRIPTION OF THE DRAWINGS

FIG. 1 is a depiction of a perspective top/side view of a transparent pressure sensing film.

FIG. 2 is a representative pressure load-release cycle for a transparent pressure sensitive film containing a plurality of organic-inorganic composite particles.

FIG. 3 is a representative pressure load-release cycle for a transparent pressure sensitive film containing a plurality of inorganic-inorganic hybrid particles.

FIG. 4 is a representative pressure load-release cycle for a transparent pressure sensitive film containing a plurality of inorganic-inorganic hybrid particles.

FIG. 5 is a representative pressure load-release cycle for a transparent pressure sensitive film containing a plurality of inorganic-inorganic hybrid particles.

FIG. 6 is a pressure versus resistance graph for a transparent pressure sensitive film containing a plurality of organic-inorganic composite particles.

FIG. 7 is a pressure versus resistance graph for a transparent pressure sensitive film containing a plurality of inorganic-inorganic hybrid particles.

FIG. 8 is a pressure versus resistance graph for a transparent pressure sensitive film containing a plurality of inorganic-inorganic hybrid particles.

FIG. 9 is a pressure versus resistance graph for a transparent pressure sensitive film containing a plurality of inorganic-inorganic hybrid particles.

FIG. 10 is a representative pressure load-release cycle comparison—before and after damp heating—for a transparent pressure sensitive film containing a plurality of organic-inorganic composite particles.

FIG. 11 is a representative pressure load-release cycle comparison—before and after damp heating—for a transparent pressure sensitive film containing a plurality of inorganic-inorganic hybrid particles.

FIG. 12 is a representative pressure load-release cycle comparison—before and after damp heating—for a transparent pressure sensitive film containing a plurality of inorganic-inorganic hybrid particles.

FIG. 13 is a representative pressure load-release cycle comparison—before and after damp heating—for a transparent pressure sensitive film containing a plurality of inorganic-inorganic hybrid particles.

### DETAILED DESCRIPTION

Touch sensitive optical displays that enable a pressure input element (i.e., a z-component) along with to the traditional location input (i.e., x,y-component) provide device manufactures with additional flexibility in device design and interface. The transparent pressure sensing films of the present invention provide a key component for such touch sensitive optical displays and offer exceptional resilience (i.e., capability of undergoing at least 500,000 taps without significant lose in performance) and weatherability (i.e., damp heat reliability at 60° C. and 90% humidity for at least 100 hours); with quick (i.e., cure times of ≦10 minutes) low temperature processability (i.e., curing temperatures of ≦130° C.).

The term “electrically non-conductive” as used herein and in the appended claims in reference to the matrix polymer means that the matrix polymer has a volume resistivity, ρᵥ, of ≧10⁸ Ω·cm as measured according to ASTM D257-14.

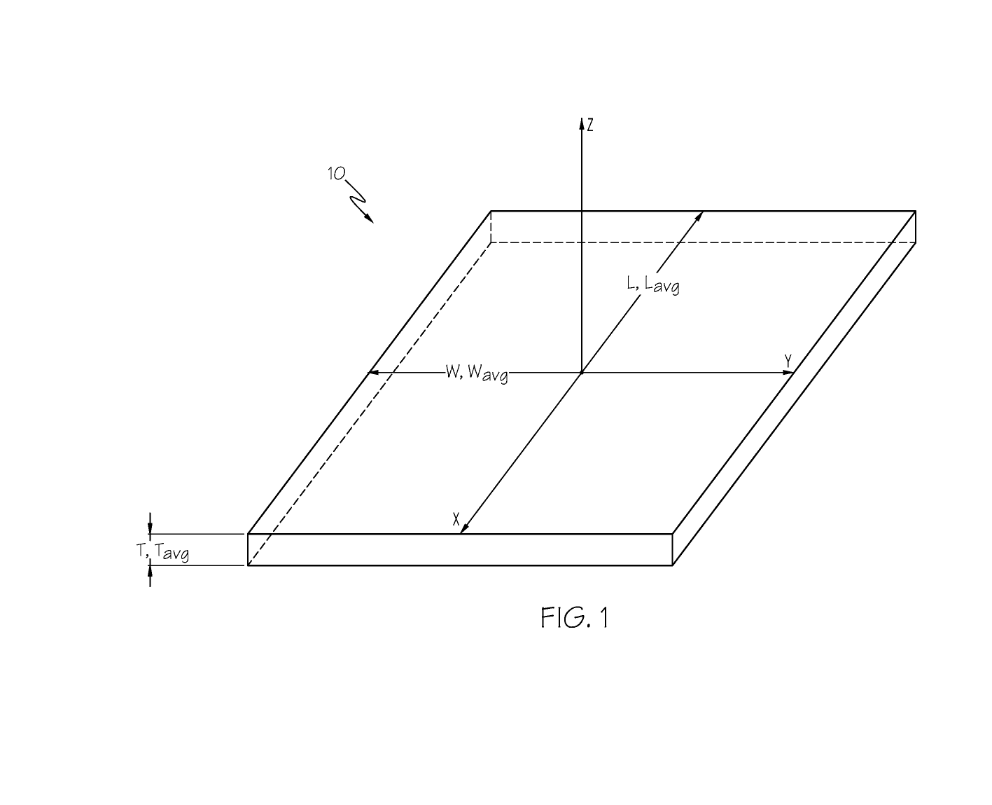

The transparent pressure sensing film (10) of the present invention, comprises: a matrix polymer; and, a plurality of hybrid particles; wherein the plurality of hybrid particles are disposed in the matrix polymer; wherein the transparent pressure sensing film (10) has a length, L, a width, W, a thickness, T, and an average thickness, T_{avg}, wherein the average thickness, T_{avg}, is 0.2 to 1,000 μm; wherein each hybrid particle in the plurality of hybrid particles, comprises a plurality of primary particles bonded together with an inorganic binder; wherein the plurality of hybrid particles has an average particle size, PS_{avg}, of 1 to 50 μm; wherein the plurality of primary particles is selected from the group consisting of conductive particles and semiconductive particles; wherein the matrix polymer is electrically non-conductive; wherein a resistivity of the transparent pressure sensing film (10) is variable in response to an applied pressure having a z-component directed along the thickness of the transparent pressure sensing film (10) such that the resistivity is reduced in response to the z-component of the applied pressure. (See FIG. 1).

The transparent pressure sensing film (10) of the present invention has a length, L, a width, W, a thickness, T, and an average thickness, T_{avg}. (See FIG. 1.) The length, L, and width, W, of the transparent pressure sensing film (10) are preferably much larger than the thickness, T, of the transparent pressure sensing film (10). The length, L, and width, W, of the transparent pressure sensing film (10) can be selected based on the size of the touch sensitive optical display device in which the transparent pressure sensing film (10) is incorporated. Alternatively, the length, L, and width, W, of the transparent pressure sensing film (10) can be selected based on the method of manufacture. For example, the transparent pressure sensing film (10) of the present invention can be manufactured in a roll-to-roll type operation; wherein the transparent pressure sensing film (10) is later cut to the desired size.

Preferably, the transparent pressure sensing film (10) of the present invention has an average thickness, T_{avg}, of 0.2 to 1,000 μm. More preferably, the transparent pressure sensing film (10) of the present invention has an average thickness, T_{avg}, of 0.5 to 100 μm. Still more preferably, the transparent pressure sensing film (10) of the present invention has an average thickness, T_{avg}, of 1 to 25 μm. Most preferably, the transparent pressure sensing film (10) of the present invention has an average thickness, T_{avg}, of 1 to 5 μm.

Preferably, the transparent pressure sensing film (10) of the present invention contains <10 wt % of the plurality of hybrid particles. More preferably, the transparent pressure sensing film (10) of the present invention contains 0.01 to 9.5 wt % of the plurality of hybrid particles. Still more preferably, the transparent pressure sensing film (10) of the present invention contains 0.05 to 5 wt % of the plurality of hybrid particles. Most preferably, the transparent pressure sensing film (10) of the present invention contains 0.5 to 3 wt % of the plurality of hybrid particles.

Preferably, the transparent pressure sensing film (10) of the present invention reversibly transitions from a high resistance quiescent state to a lower resistance non-quiescent state upon application of a force with a component in the z-direction along the thickness of the film. Preferably, the transparent pressure sensing film (10) reversibly transitions from the high resistance quiescent state to the lower resistance non-quiescent state upon application of a pressure with a component in the z-direction with a magnitude of 0.1 to 42 N/cm² (more preferably, of 0.14 to 28 N/cm²). Preferably, the transparent pressure sensing film (10) is capable of undergoing at least 500,000 cycles from the high resistance quiescent state to the lower resistance non-quiescent state while maintaining a consistent response transition. Preferably, the transparent pressure sensing film (10) has a volume resistivity of ≧10⁵ Ω·cm when in the quiescent state. More preferably, the transparent pressure sensing film (10) has a volume resistivity of ≧10⁷ Ω·cm when in the quiescent state. Most preferably, the transparent pressure sensing film (10) has a volume resistivity of ≧10⁸ Ω·cm when in the quiescent state. Preferably, the transparent pressure sensing film (10) has a volume resistivity of <10⁵ Ω·cm when subjected to a pressure with a component in the z-direction of 28 N/cm². More preferably, the transparent pressure sensing film (10) has a volume resistivity of <10⁴ Ω·cm when subjected to a pressure with a component in the z-direction of 28 N/cm². Most preferably, the transparent pressure sensing film (10) has a volume resistivity of <10³ Ω·cm when subjected to a pressure with a component in the z-direction of 28 N/cm².

Preferably, the transparent pressure sensing film (10) of the present invention has a haze, H_{Haze}, of <5% measured according to ASTM D1003-11e1. More preferably, the transparent pressure sensing film (10) of the present invention has a haze, H_{Haze}, of <4% measured according to ASTM D1003-11e1. Most preferably, the transparent pressure sensing film (10) of the present invention has a haze, H_{Haze}, of <2.5% measured according to ASTM D1003-11e1.

Preferably, the transparent pressure sensing film (10) of the present invention has a transmission, T_{Trans}, of >75% measured according to ASTM D1003-11e1. More preferably, the transparent pressure sensing film (10) of the present invention has a transmission, T_{Trans}, of >85% measured according to ASTM D1003-11e1. Most preferably, the transparent pressure sensing film (10) of the present invention has a transmission, T_{Trans}, of >89% measured according to ASTM D1003-11e1.

Preferably, the matrix polymer has a volume resistivity, ρᵥ, of ≧10⁸ Ω·cm measured according to ASTM D257-14. More preferably, the matrix polymer has a volume resistivity, ρᵥ, of ≧10¹⁰ Ω·cm measured according to ASTM D257-14. Most preferably, the matrix polymer has a volume resistivity, ρᵥ, of 10¹² to 10¹⁸ Ω·cm measured according to ASTM D257-14.

Preferably, the matrix polymer is elastically deformable from a quiescent state to a non-quiescent state when compressed through the application of a pressure with a component in the z-direction. More preferably, the matrix polymer is elastically deformable from a quiescent state to a non-quiescent state when compressed through the application of a pressure with a component in the z-direction of 0.1 to 42 N/cm². Most preferably, the matrix polymer is elastically deformable from a quiescent state to a non-quiescent state when compressed through the application of a pressure with a component in the z-direction of 0.14 to 28 N/cm².

Preferably, the matrix polymer is selected from the group consisting of (a) a combination of an alkyl cellulose and a polysiloxane; and, (b) an olefin polymer.

Preferably, the matrix polymer is a combination of an alkyl cellulose and a polysiloxane; wherein the matrix polymer comprises 25 to 100 wt % alkyl cellulose. Most preferably, the matrix polymer is a combination of an alkyl cellulose and a polysiloxane; wherein the polymer matrix comprises 25 to 75 wt % (preferably, 30 to 65 wt %; more preferably, 40 to 60 wt %) alkyl cellulose and 75 to 25 wt % (preferably, 70 to 35 wt %; more preferably, 60 to 40 wt %) polysiloxane.

Preferably, the alkyl cellulose is a C₁₋₆ alkyl cellulose. More preferably, the alkyl cellulose is a C₁₋₄ alkyl cellulose. Still preferably, the alkyl cellulose is a C₁₋₃ alkyl cellulose. Most preferably, the alkyl cellulose is an ethyl cellulose.

Preferably, the polysiloxane is a hydroxy functional silicone resin. Preferably, the polysiloxane is a hydroxy functional silicone resin having a number average molecular weight of 500 to 10,000 (preferably, 600 to 5,000; more preferably, 1,000 to 2,000; most preferably, 1,500 to 1,750). Preferably, the hydroxy functional silicone resin has an average of 1 to 15 wt % (preferably, 3 to 10 wt %; more preferably, 5 to 7 wt %; most preferably, 6 wt %) hydroxyl groups per molecule. Preferably, the hydroxy functional silicone resin is an alkylphenylpolysiloxane. Preferably, the alkylphenylpolysiloxane has a phenyl to alkyl molar ratio of 5:1 to 1:5 (preferably, 5:1 to 1:1; more preferably, 3:1 to 2:1; most preferably, 2.71:1). Preferably, the alkylphenylpolysiloxane contains alkyl radicals having an average of 1 to 6 carbon atoms per alkyl radical. More preferably, the alkylphenylpolysiloxane contains alkyl radicals having an average of 2 to 4 carbon atoms per alkyl radical. More preferably, the alkylphenylpolysiloxane contains alkyl radicals having an average of 3 carbon atoms per alkyl radical. Preferably, the alkylphenylpolysiloxane has a number average molecular weight of the 500 to 10,000 (preferably, 600 to 5,000; more preferably, 1,000 to 2,000; most preferably, 1,500 to 1,750).

Preferably, the matrix polymer is an olefin polymer. Preferably, the olefin polymer is an olefin copolymer. More preferably, the olefin copolymer is a reaction product of initial components comprising: ethylene; a branched or straight chain C₃₋₃₀ α-olefin (preferably, a branched or straight chain C₃₋₂₀ α-olefin; more preferably, an α-olefin selected from the group consisting of propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-eicosene, and, mixtures thereof; most preferably, 1-octene); a silane (preferably, an unsaturated alkoxy silane; more preferably a vinylsilane selected from the group consisting of vinyltrimethoxysilane, vinyltriethoxysilane, γ-(meth)acryloxy propyl trimethoxy silane and mixtures thereof; most preferably, vinyltrimethoxysilane); and, optionally, a polyolefin (preferably, a polyolefin selected from the group consisting of butadiene; isoprene; 4-methyl-1,3-pentadiene; 1,3-pentadiene; 1,4-pentadiene; 1,5-hexadiene; 1,4-hexadiene; 1,3-hexadiene; 1,3-octadiene; 1,4-octadiene; 1,5-octadiene; 1,6-octadiene; 1,7-octadiene; 7-methyl-1,6-octadiene; 4-ethylidene-8-methyl-1,7-nonadiene; 5,9-dimethyl-1,4,8-decatriene; and, mixtures thereof). Most preferably, the olefin copolymer is a reaction product of initial components comprising: 20 to 90 wt % (preferably, 60 to 90 wt %; more preferably, 65 to 75 wt %) ethylene; 10 to 80 wt % (preferably, 10 to 40 wt %; more preferably, 20 to 35 wt %) of a C₃₋₃₀ α-olefin (preferably, a branched or straight chain C₃₋₂₀ α-olefin; more preferably, an α-olefin selected from the group consisting of propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-eicosene, and, mixtures thereof; most preferably, 1-octene); 0.1 to 5 wt % (preferably, 0.1 to 3 wt %; more preferably, 1 to 3 wt %) a silane (preferably, an unsaturated alkoxy silane; more preferably a vinylsilane selected from the group consisting of vinyltrimethoxysilane, vinyltriethoxysilane, γ-(meth)acryloxy propyl trimethoxy silane and mixtures thereof; most preferably, vinyltrimethoxysilane); and, optionally, 0 to 10 wt % (preferably, 0 to 6 wt %) of a polyolefin (preferably, a polyolefin selected from the group consisting of butadiene; isoprene; 4-methyl-1,3-pentadiene; 1,3-pentadiene; 1,4-pentadiene; 1,5-hexadiene; 1,4-hexadiene; 1,3-hexadiene; 1,3-octadiene; 1,4-octadiene; 1,5-octadiene; 1,6-octadiene; 1,7-octadiene; 7-methyl-1,6-octadiene; 4-ethylidene-8-methyl-1,7-nonadiene; 5,9-dimethyl-1,4,8-decatriene; and, mixtures thereof). Preferably, the olefin copolymer has a glass transition temperature of 100 to 200° C. (more preferably, 130 to 150° C.) as determined using conventional differential scanning calorimetry. Preferably, the olefin copolymer has a weight average molecular weight, M_{W}, of 10,000 to 2,500,000 g/mol (more preferably, 20,000 to 500,000 g/mol; most preferably, 20,000 to 350,000 g/mol). Preferably, the olefin copolymer has a polydispersity of ≦3.5 (more preferably, ≦3.0). Preferably, the olefin copolymer has a density of ≦0.90 g/cm³ (more preferably, ≦0.88 g/cm³; most preferably, ≦0.875 g/cm³). Preferably, the olefin copolymer exhibits a density of ≧0.85 g/cm³ (more preferably, ≧0.86 g/cm³). Most preferably, the olefin copolymer is an olefin copolymer of ethylene and 1-octene with vinyltrimethoxysilane cross linking.

Preferably, the plurality of hybrid particles are disposed in the matrix polymer. More preferably, the plurality of hybrid particles are at least one of dispersed and arranged throughout the matrix polymer. Most preferably, the plurality of hybrid particles are dispersed throughout the matrix polymer.

Preferably, the plurality of hybrid particles has an average aspect ratio, AR_{avg}, of 1 to 5. More preferably, the plurality of hybrid particles has an average aspect ratio, AR_{avg}, of 1 to 2. Still more preferably, the plurality of hybrid particles has an average aspect ratio, AR_{avg}, of 1 to 1.5. Most preferably, the plurality of hybrid particles has an average aspect ratio, AR_{avg}, of 1 to 1.1.

Preferably, the plurality of hybrid particles has an average particle size, PS_{avg}, of 1 to 50 μm. More preferably, the plurality of hybrid particles has an average particles size, PS_{avg}, of 1 to 25 μm. Most preferably, the plurality of hybrid particles has an average particle size, PS_{avg}, of 1 to 10 μm.

Preferably, the plurality of hybrid particles are reversibly convertible between a high resistance state when quiescent and a low resistance state when subjected to a compressive force.

Preferably, each hybrid particle in the plurality of hybrid particles comprises a plurality of primary particles and an inorganic binder, wherein the primary particles are bonded together with the inorganic binder.

Preferably, the plurality of primary particles is selected from the group consisting of electrically conductive particles and electrically semiconductive particles. Preferably, the plurality of primary is selected from the group consisting of particles of electrically conductive metals, particles of electrically conductive metal alloys, particles of electrically conductive metal oxides, particles of electrically conductive oxides of metal alloys; and, mixtures thereof. More preferably, the plurality of primary particles is selected from the group consisting of antimony doped tin oxide (ATO) particles; silver particles; and, mixtures thereof. Most preferably, the plurality of primary particles is selected from the group consisting of antimony doped tin oxide (ATO) and silver particles.

Preferably, the inorganic binder is selected from the group consisting of silicate, zinc oxide, organosilicon compounds, aluminum oxide, calcium oxide, phosphate and combinations thereof. More preferably, the inorganic binder is selected from the group consisting of tetraethyl orthosilicate (TEOS), organosilicon compounds and mixtures thereof. Still more preferably, the inorganic binder is selected from the group consisting of TEOS and organosilicon compounds. Most preferably, the inorganic binder is TEOS.

The method of providing a transparent pressure sensing film of the present invention, comprises: providing a matrix polymer, wherein the matrix polymer is elastically deformable from a quiescent state; providing a plurality of hybrid particles, wherein each hybrid particle in the plurality of hybrid particles, comprises a plurality of primary particles bonded together with an inorganic binder; wherein the plurality of primary particles is selected from the group consisting of conductive particles and semiconductive particles; and, wherein the plurality of hybrid particles has an average particle size, PS_{avg}, of 1 to 50 μm; and, providing a solvent selected from the group consisting of terpineol, dipropylene glycol methyl ether acetate, dipropylene glycol monomethyl ether, propylene glycol n-propyl ether, dipropylene glycol n-propyl ether, cyclohexanone, butyl carbitol, propylene glycol monomethyl ether acetate, xylene and mixtures thereof (preferably, wherein the solvent is selected from the group consisting of terpineol, dipropylene glycol methyl ether acetate, dipropylene glycol monomethyl ether, and mixtures thereof; more preferably, wherein the solvent is selected from the group consisting of terpineol, dipropylene glycol methyl ether acetate and dipropylene glycol monomethyl ether; most preferably, wherein the solvent is terpineol); dispersing the matrix polymer and the plurality of hybrid particles in the solvent to form a film forming composition; depositing the film forming composition on a substrate; and, curing the film forming composition to provide the transparent pressure sensing film on the substrate.

Preferably, in the method of providing a transparent pressure sensing film of the present invention, the matrix polymer is included in the film forming composition at a concentration of 0.1 to 50 wt %. More preferably, the matrix polymer is included in the film forming composition at a concentration of 1 to 30 wt %. Most preferably, the matrix polymer is included in the film forming composition at a concentration of 5 to 20 wt %.

Preferably, in the method of providing a transparent pressure sensing film of the present invention, the film forming composition is deposited on the substrate using well known deposition techniques. More preferably, the film forming composition is applied to a surface of the substrate using a process selected from the group consisting of spray painting, dip coating, spin coating, knife coating, kiss coating, gravure coating, screen printing, ink jet printing and pad printing. More preferably, the film forming composition is applied to a surface of the substrate using a process selected from the group consisting of dip coating, spin coating, knife coating, kiss coating, gravure coating and screen printing. Most preferably, the combination is applied to a surface of the substrate by a process selected from knife coating and screen printing.

Preferably, in the method of providing a transparent pressure sensing film of the present invention, the film forming composition is cured to provide the transparent pressure sensing film on the substrate. Preferably, volatile components in the film forming composition such as the solvent are removed during the curing process. Preferably, the film forming composition is cured by heating. Preferably, the film forming composition is heated by a process selected from the group consisting of burn-off, micro pulse photonic heating, continuous photonic heating, microwave heating, oven heating, vacuum furnace heating and combinations thereof. More preferably, the film forming composition is heated by a process selected from the group consisting of oven heating and vacuum furnace heating. Most preferably, the film forming composition is heated by oven heating.

Preferably, the film forming composition is cured by heating at a temperature of 100 to 200° C. More preferably, the film forming composition is cured by heating at a temperature of 120 to 150° C. Still more preferably, the film forming composition is cured by heating at a temperature of 125 to 140° C. Most preferably, the film forming composition is cured by heating at a temperature of 125 to 135° C.

Preferably, the film forming composition is cured by heating at a temperature of 100 to 200° C. for a period of 1 to 45 minutes. More preferably, the film forming composition is cured by heating at a temperature of 120 to 150° C. for a period of 1 to 45 minutes (preferably, 1 to 30 minutes; more preferably, 5 to 15 minutes; most preferably, for 10 minutes). Still more preferably, the film forming composition is cured by heating at a temperature of 125 to 140° C. for a period of 1 to 45 minutes (preferably, 1 to 30 minutes; more preferably, 5 to 15 minutes; most preferably, for 10 minutes). Most preferably, the film forming composition is cured by heating at a temperature of 125 to 135° C. for a period of 1 to 45 minutes (preferably, 1 to 30 minutes; more preferably, 5 to 15 minutes; most preferably, for 10 minutes).

Preferably, in the method of providing a transparent pressure sensing film of the present invention, the transparent pressure sensing film provided on the substrate has an average thickness, T_{avg}, of 0.2 to 1,000 μm. More preferably, the transparent pressure sensing film provided on the substrate has an average thickness, T_{avg}, of 0.5 to 100 μm. Still more preferably, the transparent pressure sensing film provided on the substrate has an average thickness, T_{avg}, of 1 to 25 μm. Most preferably, the transparent pressure sensing film provided on the substrate has an average thickness, T_{avg}, of 1 to 5 μm.

Preferably, in the method of providing a transparent pressure sensing film of the present invention, the plurality of hybrid particles provided is selected such that the plurality of hybrid particles in the transparent pressure sensing film provided has an average particle size, PS_{avg}, wherein 0.5*T_{avg}≦PS_{avg}≦1.5*T_{avg}. More preferably, in the method of providing a transparent pressure sensing film of the present invention, the plurality of hybrid particles provided is selected such that the plurality of hybrid particles in the transparent pressure sensing film provided has an average particle size, PS_{avg}, wherein 0.75*T_{avg}≦PS_{avg}≦1.25*T_{avg}. Most preferably, in the method of providing a transparent pressure sensing film of the present invention, the plurality of hybrid particles provided is selected such that the plurality of hybrid particles in the transparent pressure sensing film provided has an average particle size, PS_{avg}, wherein T_{avg}<PS_{avg}≦1.1*T_{avg}.

The device of the present invention, comprises: a transparent pressure sensing film of the present invention; and, a controller coupled to the transparent pressure sensing film for sensing a change in resistance when pressure is applied to the transparent pressure sensing film.

Preferably, the device of the present invention, further comprises an electronic display, wherein the transparent pressure sensing film is interfaced with the electronic display. More preferably, the transparent pressure sensing film overlays the electronic display.

Some embodiments of the present invention will now be described in detail in the following Examples.

The transmission, T_{Trans}, data reported in the Examples were measured according to ASTM D1003-11e1 using a BYK Gardner Spectrophotometer. Each pressure sensing film sample on ITO glass was measured at three different points, with the average of the measurements reported.

The haze, H_{Haze}, data reported in the Examples were measured according to ASTM D1003-11e1 using a BYK Gardner Spectrophotometer. Each pressure sensing film sample on ITO glass was measured at three different points, with the average of the measurements reported.

### Comparative Example C: Organic-Inorganic Particle Preparation

An ethylene acrylic acid copolymer (0.5 g, Primacor™ 59801 available from The Dow Chemical Company) having the carboxylic acid groups 90% neutralized with potassium hydroxide was mixed with an antimony doped tin oxide (ATO) waterborne dispersion (5 g, WP-020 from Shanghai Huzheng Nanotechnology Co., Ltd.) to form a combination. The combination was then spray dried to provide composite particles.

### Example 1: Inorganic-Inorganic Particle Preparation

Antimony doped tin oxide (ATO) powder (30 g, ATO-P100, 99.95%, available from Shanghai Huzheng Nanotechnology Co., Ltd.) was dispersed into ethanol (30 g, anhydrous) to form a dispersion. Then a γ-aminopropyltriethoxysilane coupling agent (1.5 g, KH550 available from Sigma-Aldrich Co. LLC); a glycidoxypropyltrimethoxysilane coupling agent (1.5 g of KH560 available from Sigma-Aldrich Co. LLC) and ZrO₂ milling beads with a 1 mm diameter (80 g) were added to the dispersion. Water (1.5 g, deionized) was then added to the dispersion. The dispersion was then loaded into the tank of a sand milling device Type YS6334 from Shanghai Tian Feng Motors Co., Ltd. The sand milling device was set at 1,400 rpm and 10° C. The dispersion was milled in the sand mill under the noted conditions for 5 hours. The dispersion was then filtered through a 200 Mesh (Tyler) screen to remove the ZrO₂ milling beads. The dispersion was then diluted 200 g with ethanol in a 500 mL round bottom flask. The flask was then placed in an oil bath set at 80° C. and left to stir overnight. A dried product hybrid particle powder was then obtained from the dispersion by removing the ethanol and water via vacuum evaporation and oven drying at 160° C. The dried product hybrid particle powder wash then milled for two (2) hours in a planetary grind mill type QM-3SP2 from Nanjing NanDa Instrument Plant set at 400 rpm with 300 g agate milling balls having a range of diameters from 3 to 10 mm to provide a milled product hybrid particle powder.

### Example 2: Inorganic-Inorganic Particle Preparation

Example 2 was identical to Example 1 except that tetraethylorthosilicate (TEOS) (7 g, available from Sigma-Aldrich Co. LLC) and water (2.5 g, deionized) were then added to the dispersion in the 500 mL round bottom flask before the flask was then placed in an oil bath set at 80° C. and left to stir overnight.

### Examples 3-5: Inorganic-Inorganic Particle Sizing

In each of Examples 3-5, a sample (4.6 g) of the milled product hybrid particle powder prepared according to Example 1 or Example 2 as noted in TABLE 1 was dispersed in ethylcellulose (33 g of 10.5% solution available from The Dow Chemical Company as Ethocel™ standard 10 cellulose, CAS#9004-57-3) to form a dispersion. Zirconium oxide (ZrO₂) milling beads with a 1 mm were then added to the dispersion in the amount noted in TABLE 1. The ZrO₂ milling bead containing dispersions were then loaded into the tank of a sand milling device Type YS6334 from Shanghai Tian Feng Motors Co., Ltd. The sand milling device was set at 1,400 rpm and 10° C. The dispersions were then each milled in the sand mill under the noted conditions for ninety minutes. The sand milled dispersions were then filtered through a 400 Mesh (Tyler) screen to remove the ZrO₂ beads and to provide a mother ink containing the hybrid, inorganic-inorganic particles.

TABLE 1

| | Milled Hybrid | |
|---|---|---|
| Ex. # | Particle Powder | ZrO₂ Beads (g) |
| 3 | Ex. 2 | 80 |
| 4 | Ex. 2 | 115 |
| 5 | Ex. 1 | 115 |

### Comparative Example CI and Examples 6-8: Pressure Sensing Ink Preparation

The pressure sensing ink of Comparative Example CI was prepared by ultrasonically dispersing the composite particles prepared according to Comparative Example C into a 9 wt % solution of a 7:3 weight ratio polymer mixture of ethylcellulose (Ethocel™ standard 10 cellulose available from The Dow Chemical Company) and branched propylphenylpolysiloxane having an average of 6 wt % hydroxyl groups per molecule (Z6018 available from Dow Corning) in a 7:3 weight ratio solvent mixture of terpineol and dipropylene glycol methyl ether acetate. The pressure sensing ink of Comparative Example CI contained 2 wt % composite particles relative to the weight of the polymer solids.

The pressure sensing inks of Examples 6-8 were prepared by diluting the mother inks prepared according to Examples 3-5, respectively. That is, the mother inks prepared according to Examples 6-8 were directly diluted with a 9 wt % solution of a 7:3 weight ratio polymer mixture of ethylcellulose (Ethocel™ standard 10 cellulose available from The Dow Chemical Company) and branched propylphenylpolysiloxane having an average of 6 wt % hydroxyl groups per molecule (Z6018 available from Dow Corning) in a 7:3 weight ratio solvent mixture of terpineol and dipropylene glycol methyl ether acetate. The pressure sensing ink of Examples 6-8 contained 2 wt % hybrid particles relative to the weight of the polymer solids.

### Comparative Example CF and Examples 9-11: Pressure Sensing Film Preparation

Pressure sensing films of Comparative Example CF and Examples 9-11 were provided by depositing the pressure sensing inks prepared according to Comparative Example CI and Examples 6-8, respectively, on the indium-tin oxide coating of an indium-tin oxide (ITO, 15Ω per square) coated glass slide (Length=119 mm; width=77 mm; thickness=0.5 mm) (available from Wesley Tech. Co., Ltd., China). In each of Comparative Example CF and Examples 9-11 a mechanical drawdown process with a 25 μm blade gap was used to form the film. The films were then cured at 130° C. for 10 minutes. The dried film thickness for each of the deposited pressure sensing films formed was measured using an atomic force microscope (AFM). The measured thicknesses are reported in TABLE 2.

TABLE 2

| Ex. # | Film thickness (in μm) |
|---|---|
| CF | 1.5 |
| 9 | 1.5 |
| 10 | 1.5 |
| 11 | 1.5 |

### Initial Pressure Sensing Film Response

An indium-tin oxide coated polyethylene terephthalate film was placed over the pressure sensing film prepared according to each of Comparative Example CF and Examples 9-11 with the indium-tin oxide (ITO) coated surface facing the pressure sensing film. The resistance response of each of the pressure sensing films was then evaluated at three different points using a robot arm integrated with a spring to control the input pressure on a steel disk probe (3 mm diameter) placed on the untreated surface of the polyethylene terephthalate film. The input pressure exerted on the film stack through the steel disk probe was varied between 1 and 200 g.

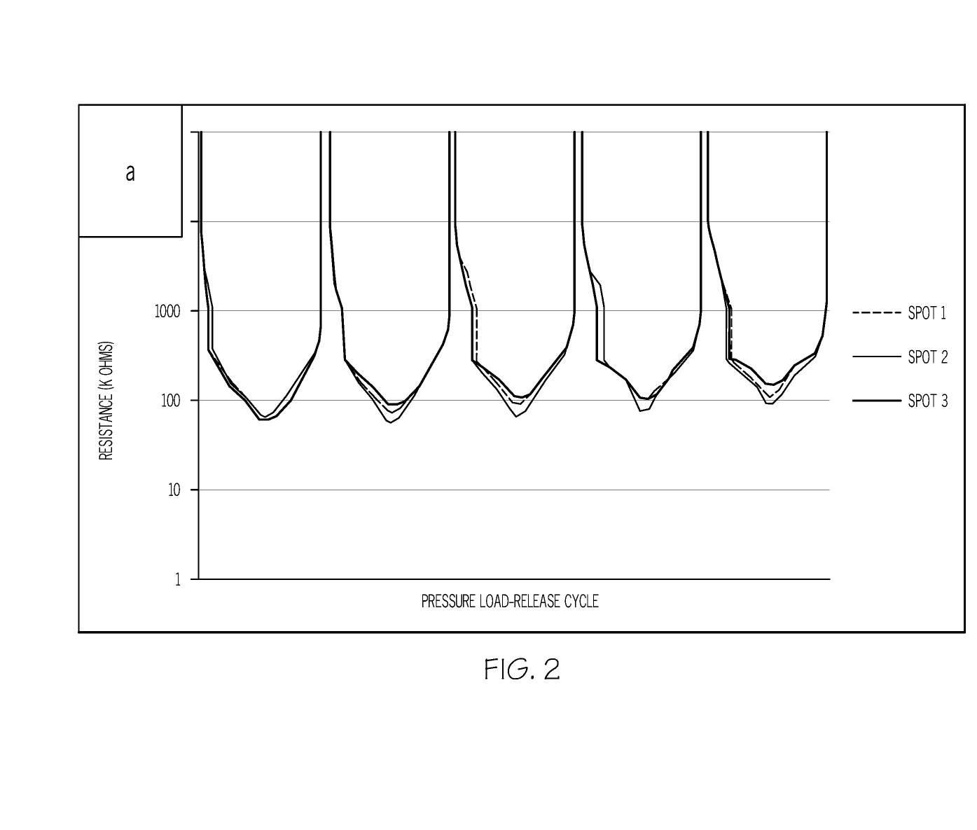

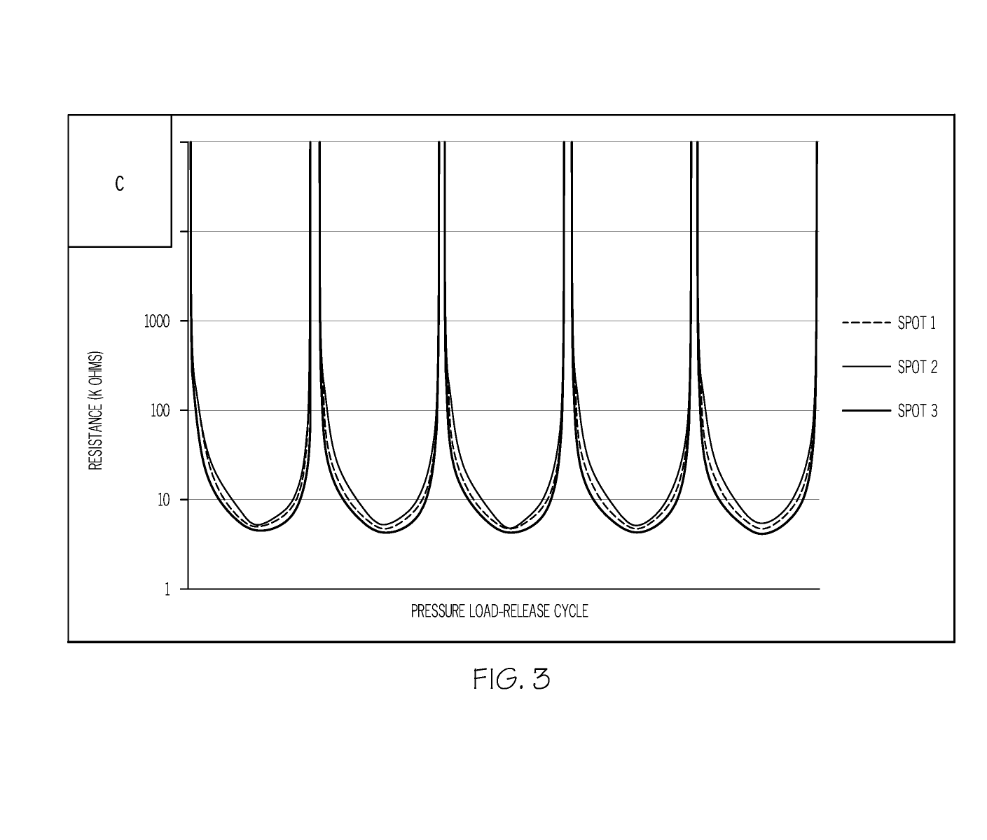

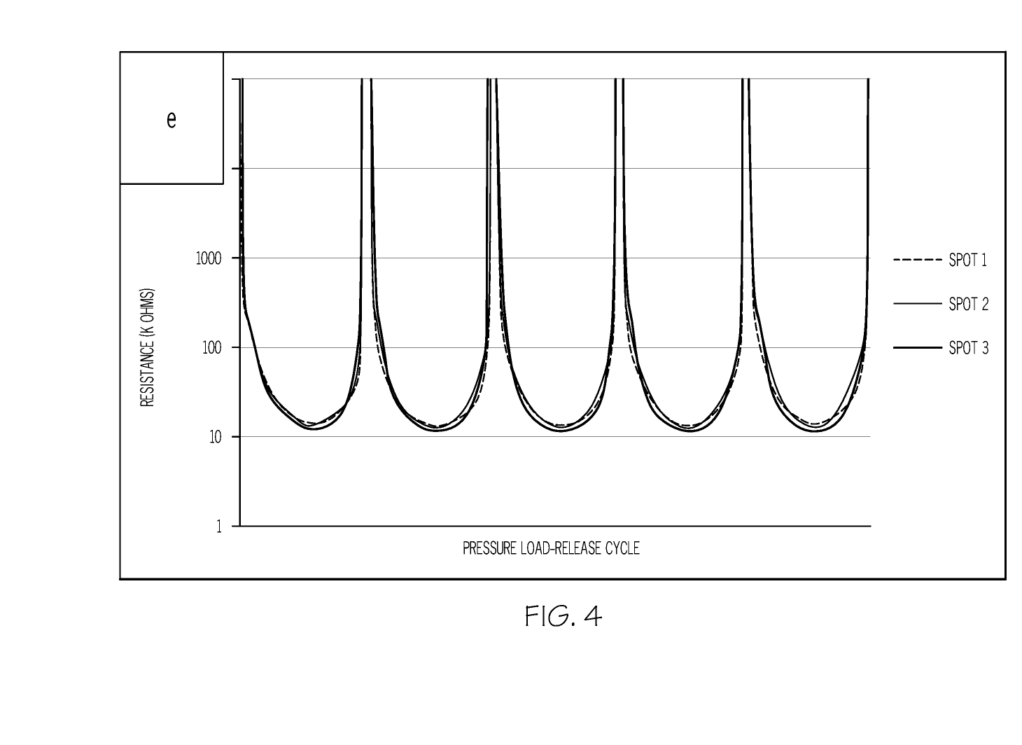

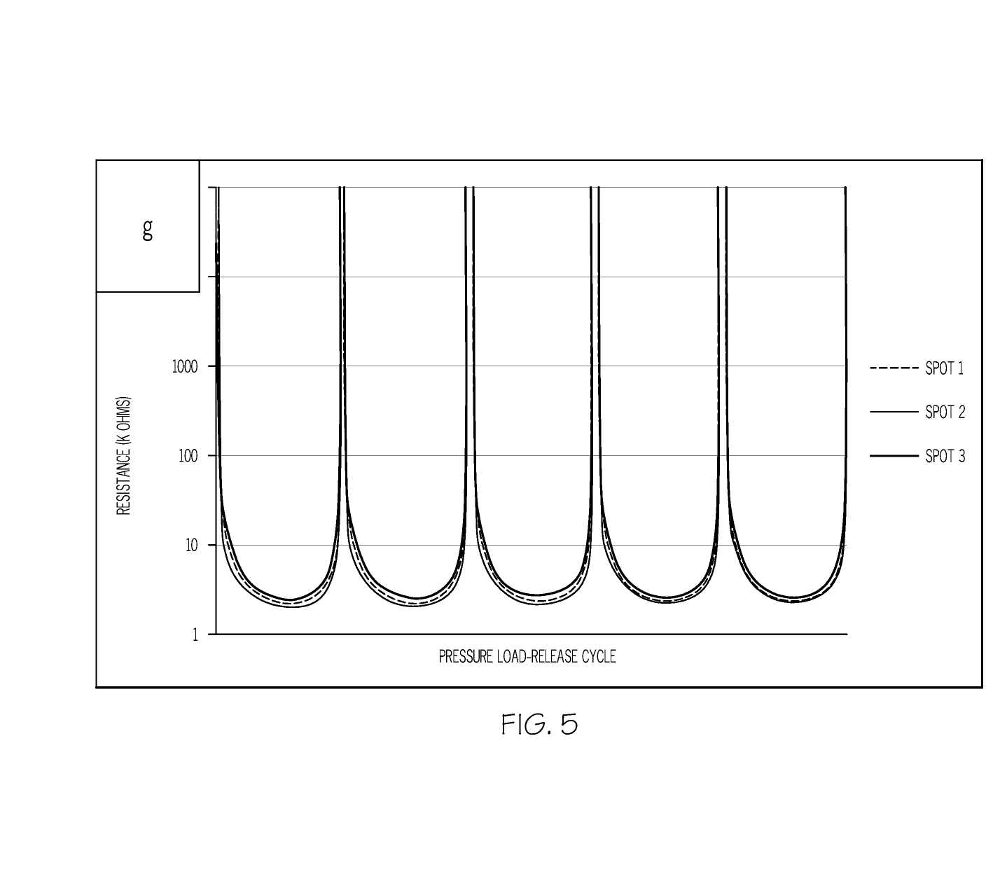

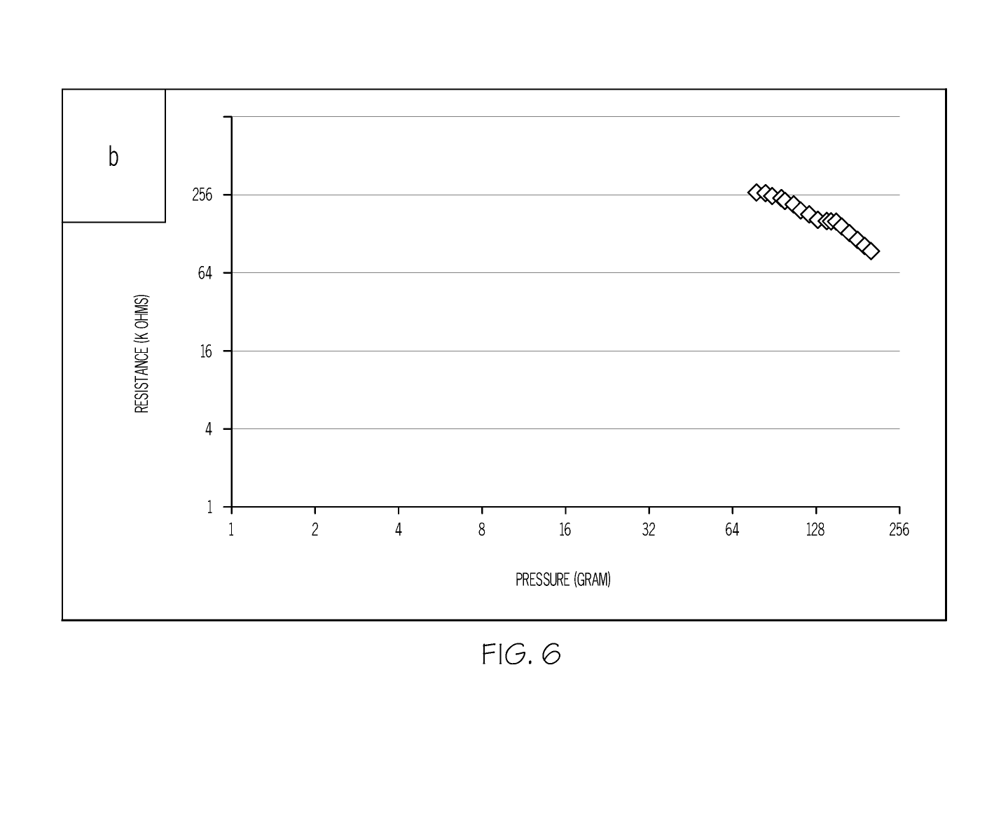

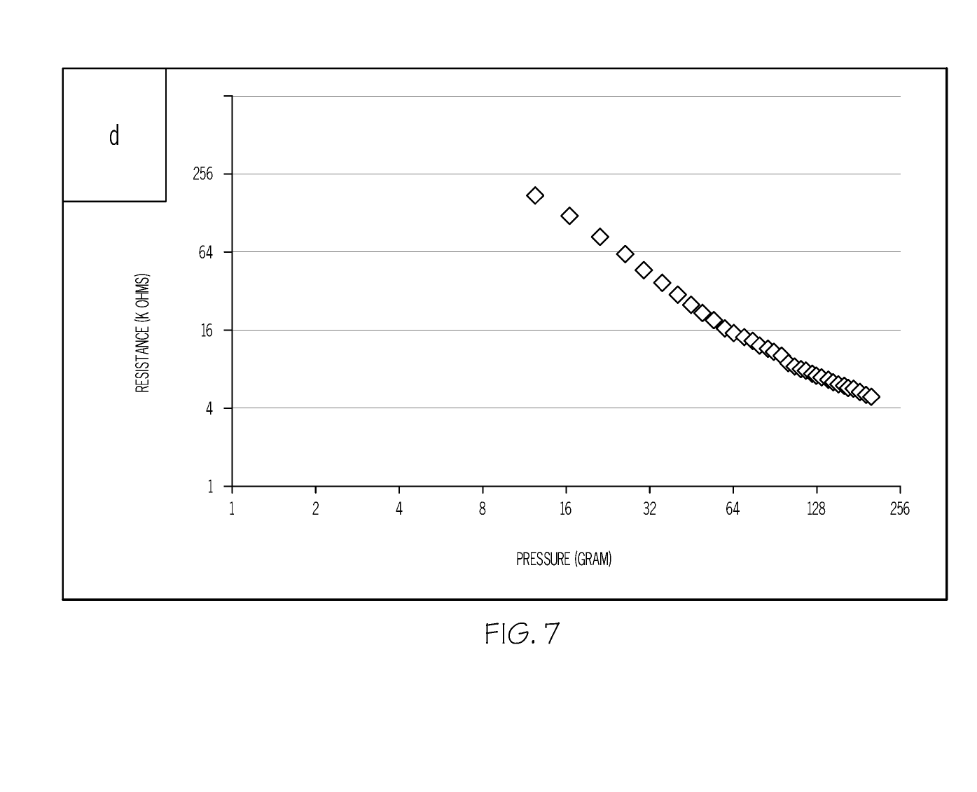

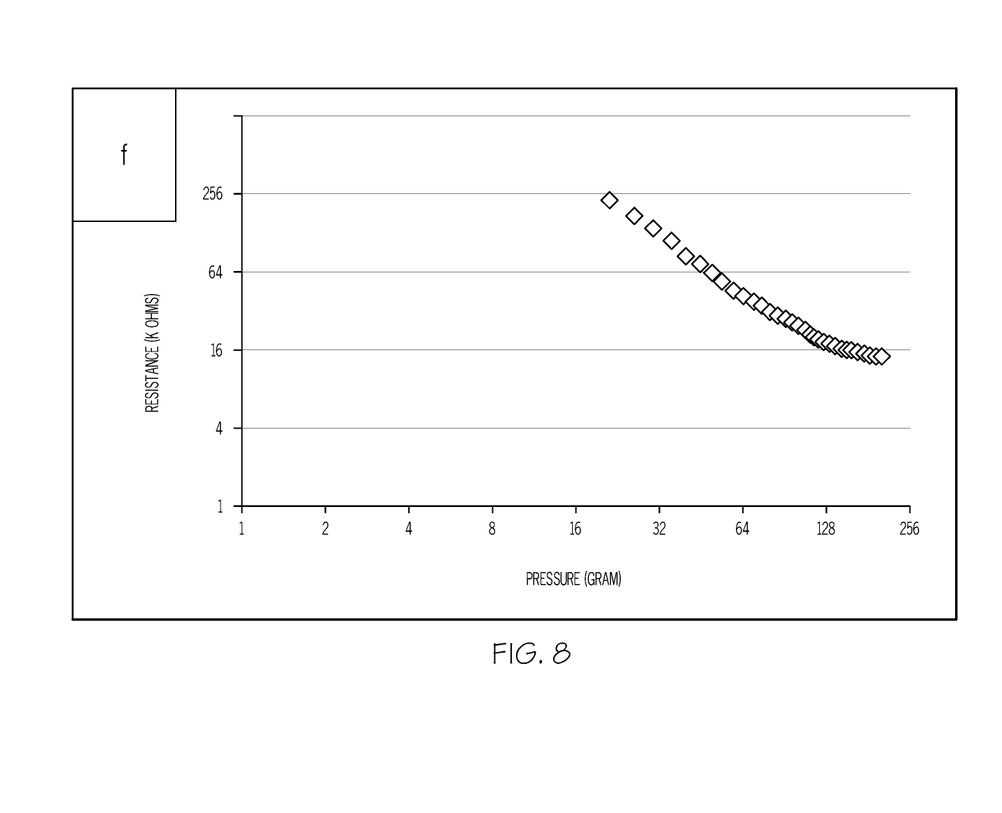

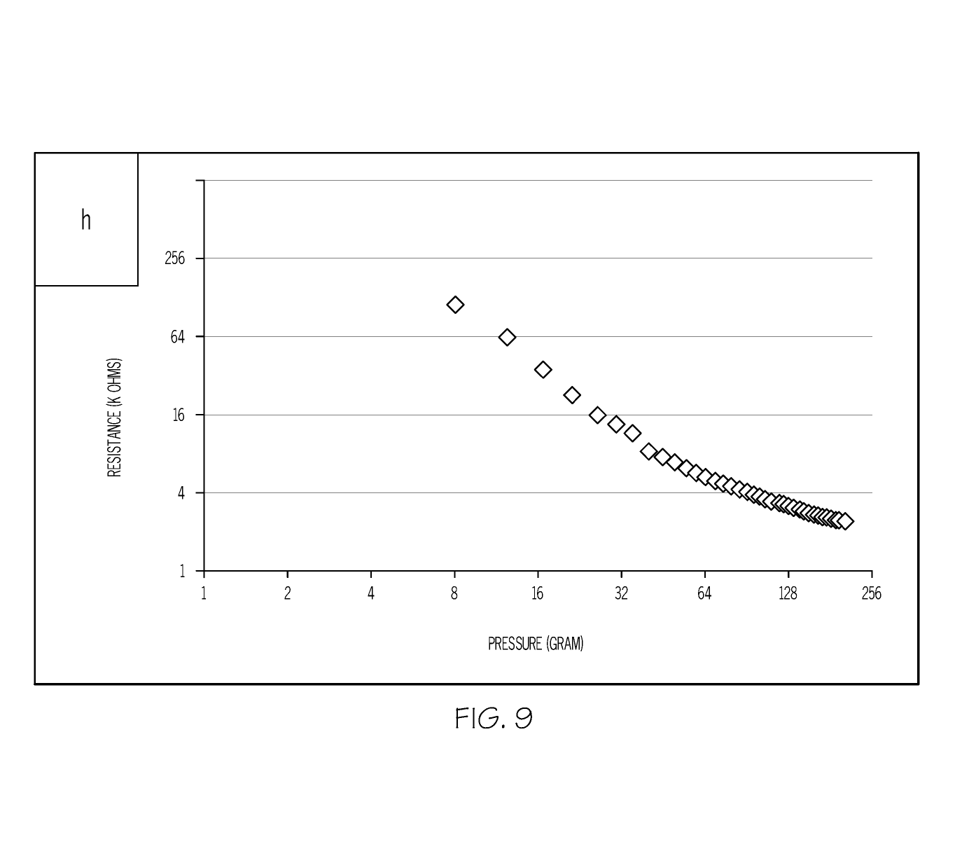

The resistance exhibited by the pressure sensing films was recorded using a resistance meter having one probe connected to the indium tin oxide coated glass slide and the one probe connected to the indium-tin oxide coated polyethylene terephthalate film. Representative pressure load release cycles for the pressure sensing films prepared according to each of Comparative Example CF and Examples 9-11 are provided in FIGS. 2-5, respectively. A graph of the pressure versus resistance for the pressure sensing films prepared according to each of Comparative Example CF and Examples 9-11 are provided in FIGS. 6-9, respectively.

### Pressure Sensing Film Damp Heat Resistance

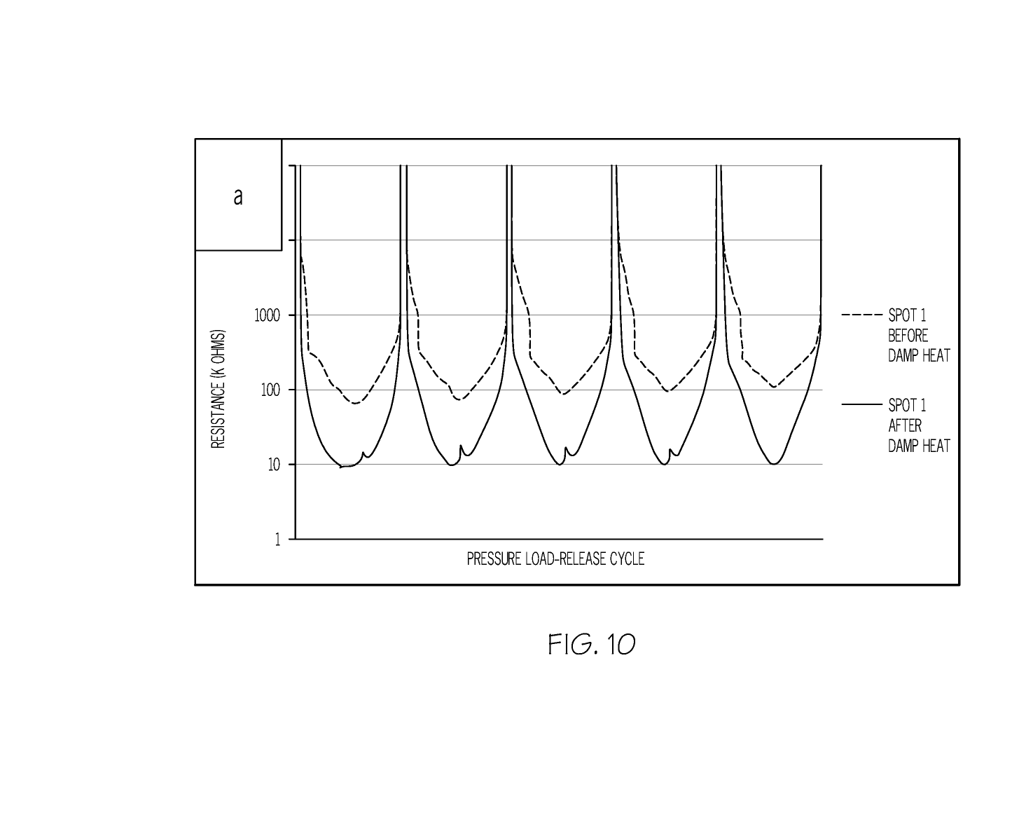

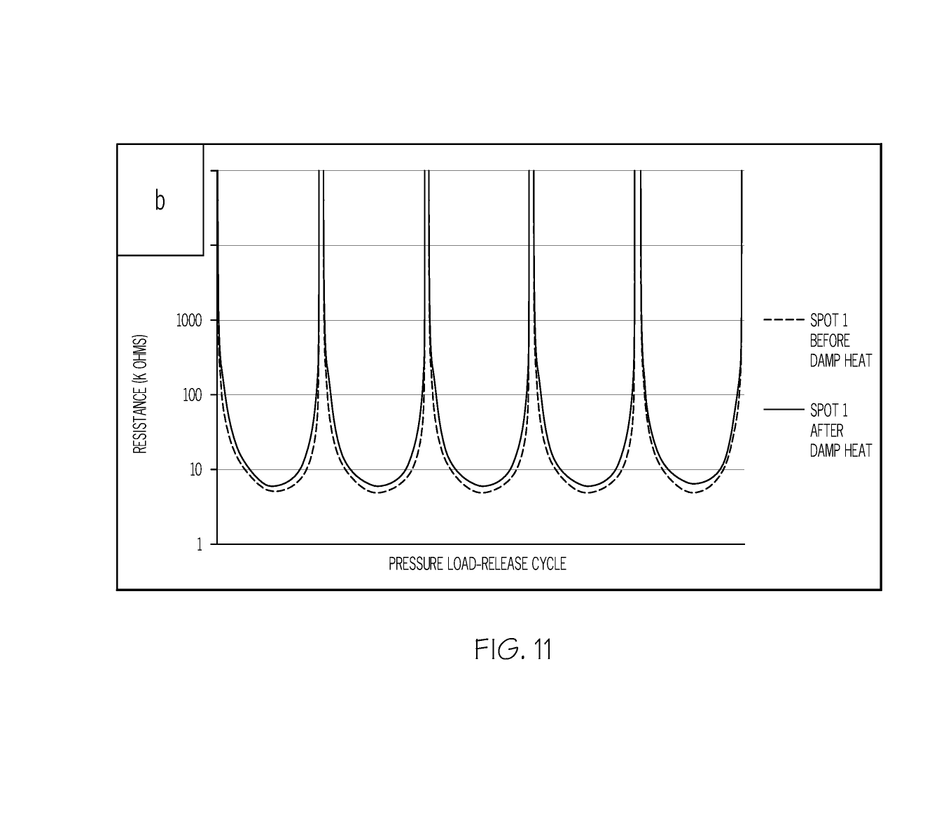

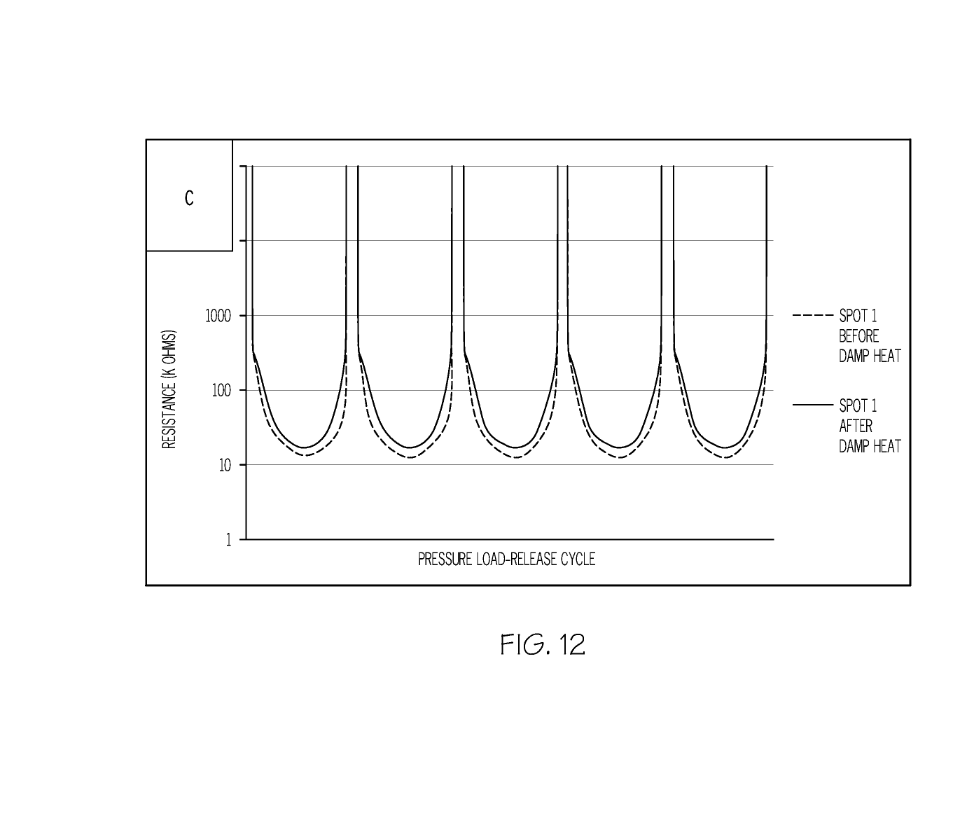

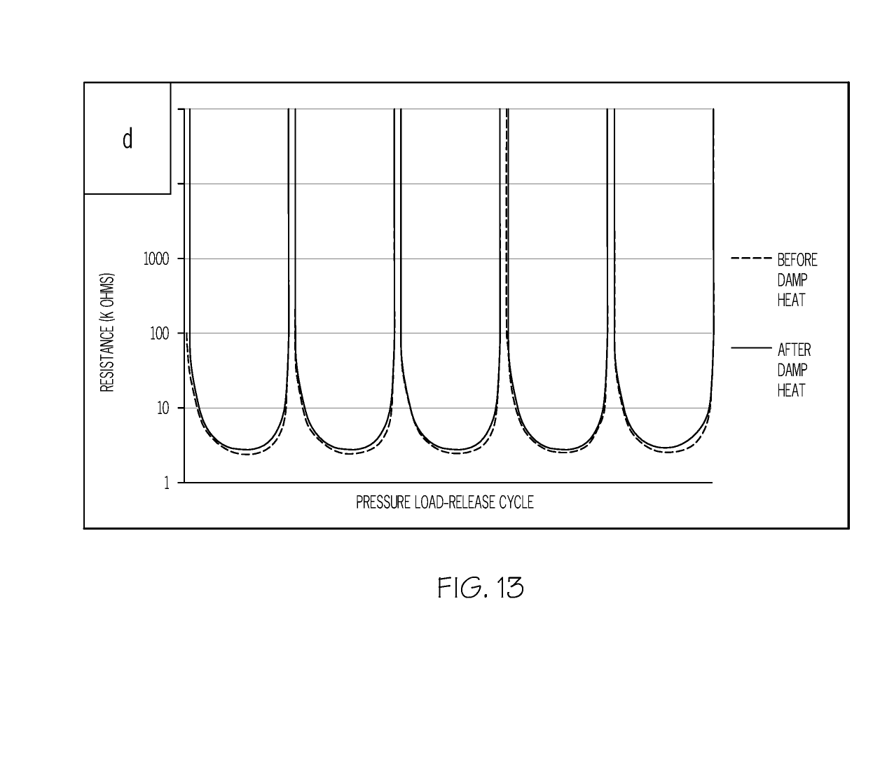

The damp heat resistance of the pressure sensing films of Comparative Example CF and Examples 9-11 was evaluated. After the initial pressure sensing film response testing described above, the films were placed in an oven set at 70° C. and a relative humidity of 90% for 24 hours. The films were then removed from the oven and their pressure sensing response was reevaluated. The results are shown for the pressure sensing films of Comparative Example CF and Examples 9-11 in FIGS. 10-13, respectively. The dotted lines in each of FIGS. 10-13 correspond to the initial pressure sensing film response. The solids lines in each of FIGS. 10-13 correspond to the pressure sensing film response following the oven treatment.

### Pressure Sensing Film Transparency and Haze

The transmission, T_{Trans}, and haze, H_{Haze}, of the pressure sensing films (deposited on the ITO coated polyethylene terephthalate film substrates) prepared according to each of Comparative Examples CF and Examples 9-11 are provided in TABLE 3.

TABLE 3

| Ex # | T_{Tans} (in %) | H_{Haze} (in %) |
|---|---|---|
| untreated ITO | 86.7 | 0.08 |
| glass slide | | |
| CF | 89.4 | 2.15 |
| 9 | 89.2 | 2.38 |
| 10 | 88.9 | 2.13 |
| 11 | 89.0 | 2.23 |

We claim:

1. A transparent pressure sensing film, comprising:
a matrix polymer; and
a plurality of hybrid particles;
wherein the plurality of hybrid particles are disposed in the matrix polymer;
wherein the transparent pressure sensing film has a length, a width, a thickness, T, and an average thickness, T_{avg};
wherein the average thickness, T_{avg}, is 0.2 to 1,000 μm;
wherein each hybrid particle in the plurality of hybrid particles, comprises a plurality of primary particles bonded together with an inorganic binder;
wherein the plurality of hybrid particles has an average particle size, PS_{avg}, of 1 to 50 μm;
wherein the plurality of primary particles is selected from the group consisting of electrically conductive particles and electrically semiconductive particles;
wherein the matrix polymer is electrically non-conductive;
wherein an electrical resistivity of the transparent pressure sensing film is variable in response to an applied pressure having a z-component directed along the thickness, T, of the transparent pressure sensing film such that the electrical resistivity is reduced in response to the z-component of the applied pressure.

2. The transparent pressure sensing film of claim 1, wherein the plurality of primary particles is selected from the group consisting of antimony doped tin oxide (ATO) particles and silver particles.

3. The transparent pressure sensing film of claim 1, wherein the transparent pressure sensing film contains <10 wt % of the plurality of hybrid particles.

4. The transparent pressure sensing film of claim 1, wherein the matrix polymer is a combination of an alkyl cellulose and a polysiloxane.

5. The transparent pressure sensing film of claim 1, wherein the matrix polymer is an olefin polymer.

6. A device comprising:
a transparent pressure sensing film according to claim 1; and
a controller coupled to the transparent pressure sensing film for sensing a change in resistance when pressure is applied to the transparent pressure sensing film.

7. The device of claim 6, further comprising:
an electronic display,
wherein the transparent pressure sensing film is interfaced with the electronic display.

8. The device of claim 7, wherein the transparent pressure sensing film overlays the electronic display.

9. A method of providing a transparent pressure sensing film, comprising:
providing a matrix polymer, wherein the matrix polymer is elastically deformable from a quiescent state;
providing a plurality of hybrid particles, wherein each hybrid particle in the plurality of hybrid particles, comprises a plurality of primary particles bonded together with an inorganic binder; wherein the plurality of primary particles is selected from the group consisting of conductive particles and semiconductive particles; and, wherein the plurality of hybrid particles has an average particle size, PS_{avg}, of 1 to 50 μm; and,
providing a solvent selected from the group consisting of terpineol, dipropylene glycol methyl ether acetate, dipropylene glycol monomethyl ether, propylene glycol n-propyl ether, dipropylene glycol n-propyl ether, cyclohexanone, butyl carbitol, propylene glycol monomethyl ether acetate, xylene and mixtures thereof;
dispersing the matrix polymer and the plurality of hybrid particles in the solvent to form a film forming composition;
depositing the film forming composition on a substrate; and,
curing the film forming composition to provide the transparent pressure sensing film on the substrate.
